(19) United States
(12) Patent Application Publication
(10) Pub. No.: US 2023/0162759 A1
(43) Pub. Date: May 25, 2023

(54) GLASS DISK FOR MAGNETIC RECORDING MEDIUM AND MAGNETIC RECORDING DEVICE USING THE SAME

(71) Applicant: NIPPON ELECTRIC GLASS CO., LTD., Otsu-shi, Shiga (JP)

(72) Inventor: Mayu NISHIMIYA, Otsu-shi, Shiga (JP)

(73) Assignee: NIPPON ELECTRIC GLASS CO., LTD., Otsu-shi, Shiga (JP)

(21) Appl. No.: 17/912,081

(22) PCT Filed: May 18, 2021
(86) PCT No.: PCT/JP2021/018708

§ 371 Date: Sep. 16, 2022

(30) Foreign Application Priority Data
Jun. 2, 2020 (JP) 2020-095964

(51) Int. Cl. G11B 5/73; C03C 3/093; C03C 3/091; C03C 3/087

(52) U.S. Cl. CPC G11B 5/73921; G11B 5/73913; C03C 3/093; C03C 3/091; C03C 3/087

(57) ABSTRACT

A glass disk for a magnetic recording medium of the present invention has a disk shape, and has a strain point of 695° C. to 780° C., a temperature at 10^{4.5} dPa·s of 1300° C. or lower, and a Young's modulus of 78 GPa or higher.

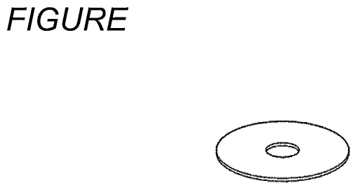

### TECHNICAL FIELD

The present invention relates to a glass disk for a magnetic recording medium and a magnetic recording device using the same.

### BACKGROUND ART

A magnetic recording device includes a magnetic recording medium in which a magnetic layer is formed on a magnetic recording medium substrate, and can record information using the magnetic layer. In the related art, an aluminum alloy substrate is used as the magnetic recording medium substrate used in the magnetic recording device. At present, with a demand for a high recording density, thinning of a magnetic medium substrate is studied. However, when an aluminum alloy substrate is thinned, rigidity is lost, and thus attention is focused on a glass disk (a glass substrate) excellent in rigidity, flatness, smoothness, and the like.

In recent years, in order to meet a need for a higher recording density, a magnetic recording medium using an energy-assisted magnetic recording method, that is, an energy-assisted magnetic recording medium is studied. Also in the energy-assisted magnetic recording medium, a glass disk is used, and a magnetic layer or the like is formed on a surface of the glass disk. In the energy-assisted magnetic recording medium, an ordered alloy having a large magnetic anisotropy coefficient Ku (hereinafter referred to as a “high Ku”) is used as a magnetic material of the magnetic layer.

In order to increase a degree of ordering (regularity) of the magnetic layer and achieve the high Ku, a base material including the glass disk may be heat-treated at a high temperature of about 800° C. at the time of film formation of the magnetic layer, or before or after the film formation. As a recording density is higher, the heat treatment temperature needs to be higher, and thus higher heat resistance than that of the related-art glass disk for a magnetic recording medium is required. After the magnetic layer is formed, laser irradiation may be performed on the base material including the glass disk. Such heat treatment and laser irradiation are also intended to increase an annealing temperature and coercive force of a magnetic layer containing a FePt-based alloy or the like.

### SUMMARY OF INVENTION

### Technical Problem

A glass disk for a magnetic recording medium is required to have high rigidity (Young's modulus) in order not to cause large deformation at the time of high-speed rotation. More specifically, in a disk-shaped magnetic recording medium, information is written and read along a rotation direction while the medium is rotated at a high speed around a central axis and a magnetic head is moved in a radial direction. In recent years, a rotational speed for increasing a writing speed and a reading speed is increasing from 5400 rpm to 7200 rpm, and further to 10000 rpm, but in the disk-shaped magnetic recording medium, a position for recording information is assigned in advance according to a distance from the central axis. Therefore, when a glass disk is deformed during rotation, the magnetic head is displaced, which makes accurate reading difficult.

In recent years, by mounting a dynamic flying height (DFH) mechanism on a magnetic head, a gap between a recording and reproducing element portion of the magnetic head and a surface of a magnetic recording medium is greatly narrowed (a flying height is reduced), and a higher recording density is achieved. The DFH mechanism is a mechanism in which a heating unit such as an extremely small heater is provided in the vicinity of the recording and reproducing element portion of the magnetic head, and a periphery of the element portion is alone thermally expanded toward a medium surface direction. By providing such a mechanism, a distance between the magnetic head and a magnetic layer of the medium is reduced, and thus signals of smaller magnetic particles can be picked up, and a high recording density can be achieved. On the other hand, the gap between the recording and reproducing element portion of the magnetic head and the surface of the magnetic recording medium is extremely small, for example, 2 nm or less, and thus the magnetic head may collide with the surface of the magnetic recording medium even with a slight impact. As a rotation speed is higher, this tendency is more remarkable. Therefore, it is important to prevent occurrence of bending and flapping (fluttering) of a glass disk which may cause the collision at the time of high-speed rotation.

Further, with a recent increase in use of data centers and servers worldwide, it is required to reduce the cost of these glass disks. Formability is important for reducing the cost of the glass disks. Further, it is also effective to adopt an overflow down-draw method or a float method to form a large glass substrate with a thickness close to a thickness of a product and process the large glass substrate into a circular disc shape.

The present invention has been made in view of the above circumstances, and an object of the present invention is to devise a glass disk for a magnetic recording medium that is less likely to cause bending and flapping (fluttering) at the time of high-speed rotation, has sufficient heat resistance to achieve a very high recording density, and contributes to cost reduction.

### Solution to Problem

As a result of repeating various experiments, the present inventors have found that the above-described technical problems can be solved by strictly regulating glass properties of a glass disk, and have proposed the present invention. That is, a glass disk for a magnetic recording medium of the present invention has a disk shape, and has a strain point of 695° C. to 780° C., a temperature at 10^{4.5} dPa·s of 1300° C. or lower, and a Young's modulus of 78 GPa or higher. In the glass disk for a magnetic recording medium of the present invention, a circular opening is preferably formed in a central portion. Here, the term “strain point” refers to a value measured based on a method of ASTM C336. The term “temperature at 10^{4.5} dPa·s” refers to a value measured by a platinum sphere pull up method. The term “Young's modulus” may be measured by a known resonance method.

The FIGURE is an upper perspective view showing a disk shape. The disk shape refers to a circular disc shape, and is preferably a shape in which a circular opening is formed in a central portion (see the FIGURE).

In the glass disk for a magnetic recording medium of the present invention, the strain point is regulated to 695° C. or higher. Accordingly, even when heat treatment at a high temperature such as thermal assist or laser irradiation is performed, the glass disk is less likely to be deformed. As a result, a higher heat treatment temperature can be adopted when achieving a high Ku, and thus a magnetic recording device having a high recording density can be easily manufactured.

In addition, in the glass disk for a magnetic recording medium of the present invention, the temperature at a viscosity in high temperature of 10^{4.5} dPa·s is regulated to 1300° C. or lower. Accordingly, formability is improved, which can contribute to cost reduction of the glass disk.

Further, in the glass disk for a magnetic recording medium of the present invention, the Young's modulus is regulated to 78 GPa or higher. Accordingly, bending and flapping (fluttering) of the glass disk are less likely to occur at the time of high-speed rotation, and thus a collision between an information recording medium and a magnetic head can be prevented.

The glass disk for a magnetic recording medium of the present invention preferably contains, as a glass composition, in terms of mol %, 60% to 71% of SiO₂, 10% to 16% of Al₂O₃, 0% to 5% of B₂O₃, 0% to 0.1% of Na₂O, 0% to 1% of K₂O, 0% to 12% of MgO, 0% to 12% of CaO, 0% to 10% of SrO, 0% to 10% of BaO, 0% to 1% of ZrO₂, and 0% to 1% of SnO₂.

In the glass disk for a magnetic recording medium of the present invention, an average surface roughness Ra of a surface is preferably 1.0 nm or less. Accordingly, magnetic properties can be improved even if a bit size is miniaturized for a high recording density. Here, the term “average surface roughness Ra of a surface” refers to an average surface roughness Ra of main surfaces (both surfaces) excluding end surfaces, and can be measured by, for example, an atomic force microscope (AFM).

In the glass disk for a magnetic recording medium of the present invention, an average linear transmittance in an optical path length of 1 mm and a wavelength range of 350 nm to 1500 nm is preferably 70% or more.

In the glass disk for a magnetic recording medium of the present invention, a magnetic layer is preferably provided on a surface. Accordingly, it is easy to apply the glass disk to an energy-assisted magnetic recording medium.

A glass substrate for a magnetic recording medium of the present invention has a strain point of 695° C. to 740° C., a temperature at 10⁴⁵ dPa·s of 1300° C. or lower, and a Young's modulus of 78 GPa or higher.

The glass substrate for a magnetic recording medium of the present invention preferably contains, as a glass composition, in terms of mol %, 60% to 71% of SiO₂, 10% to 16% of Al₂O₃, 0% to 5% of B₂O₃, 0% to 0.1% of Na₂O, 0% to 1% of K₂O, 0% to 12% of MgO, 0% to 12% of CaO, 0% to 10% of SrO, 0% to 10% of BaO, 0% to 1% of ZrO₂, and 0% to 1% of SnO₂.

A magnetic recording device of the present invention preferably includes the above-described glass disk for a magnetic recording medium.

### BRIEF DESCRIPTION OF DRAWINGS

The FIGURE is an upper perspective view showing a disk shape.

### DESCRIPTION OF EMBODIMENTS

In a glass disk for a magnetic recording medium of the present invention, a strain point is 695° C. or higher, preferably 697° C. or higher, 700° C. or higher, 702° C. or higher, 705° C. or higher, 710° C. or higher, 711° C. or higher, 712° C. or higher, 713° C. or higher, 714° C. or higher, and particularly 715° C. or higher. When the strain point is too low, it is difficult to perform heat treatment at a high temperature and laser irradiation, and it is difficult to manufacture a magnetic recording medium having a high recording density. On the other hand, when the strain point is too high, a melting temperature and a forming temperature are high, and thus production efficiency of a glass substrate is likely to be decreased. Therefore, the strain point is 780° C. or lower, preferably 775° C. or lower, 770° C. or lower, 768° C. or lower, 765° C. or lower, 763° C. or lower, 760° C. or lower, 758° C. or lower, 755° C. or lower, 753° C. or lower, 750° C. or lower, 748° C. or lower, 745° C. or lower, 743° C. or lower, 740° C. or lower, 738° C. or lower, 735° C. or lower, 733° C. or lower, 730° C. or lower, 725° C. or lower, 720° C. or lower, and particularly 715° C. or lower. A most preferred range of the strain point is 715° C. to 770° C.

In the glass disk for a magnetic recording medium of the present invention, as a temperature at a viscosity in high temperature of 10⁴⁵ dPa·s is lower, a load applied to forming equipment can be more reduced. The temperature at 10⁴⁵ dPa·s is 1300° C. or lower, preferably 1290° C. or lower, 1280° C. or lower, 1275° C. or lower, 1270° C. or lower, 1265° C. or lower, 1260° C. or lower, 1255° C. or lower, and particularly 1250° C. or lower. On the other hand, when the temperature at 10⁴⁵ dPa·s is too low, the strain point cannot be designed to be high. Therefore, the temperature at 10⁴⁵ dPa·s is preferably 1150° C. or higher, 1170° C. or higher, 1180° C. or higher, 1185° C. or higher, 1190° C. or higher, 1195° C. or higher, and particularly 1200° C. or higher.

In the glass disk for a magnetic recording medium of the present invention, a Young's modulus is 78 GPa or higher, preferably 80 GPa or higher, 81 GPa or higher, 82 GPa or higher, and particularly preferably 83 GPa to 100 GPa. When the Young's modulus is too low, bending and flapping (fluttering) of the glass disk are likely to occur at the time of high-speed rotation, and thus an information recording medium and a magnetic head are likely to collide with each other.

The glass disk for a magnetic recording medium of the present invention preferably contains, as a glass composition, in terms of mol %, 60% to 71% of SiO₂, 10% to 16% of Al₂O₃, 0% to 5% of B₂O₃, 0% to 0.1% of Na₂O, 0% to 1% of K₂O, 0% to 12% of MgO, 0% to 12% of CaO, 0% to 10% of SrO, 0% to 10% of BaO, 0% to 1% of ZrO₂, and 0% to 1% of SnO₂. Reasons for limiting a content range of each component as described above are shown below. In the description of the content range of each component, “%” means “mol %”.

When a content of SiO₂ is too small, chemical resistance, particularly acid resistance, is likely to be decreased, and the strain point is likely to be decreased. On the other hand, when a content of SiO₂ is too large, an etching rate with hydrofluoric acid or a mixed solution of hydrofluoric acid is likely to be decreased, the viscosity in high temperature is increased, meltability is likely to be decreased, and further, SiO₂-based crystals, particularly cristobalite, are precipitated, and a liquidus viscosity is likely to be decreased. Therefore, an upper limit content of SiO₂ is suitably 71%, 70.5%, 70%, 69.5%, 69%, 68.5%, 68%, and particularly 67.5%, and a lower limit content is suitably 60%, 61%, 62%, 62.5%, 63%, 63.5%, 64%, 64.5%, and particularly 65%. A most preferred content range is 66% to 70.5%.

When a content of Al₂O₃ is too small, the strain point is decreased, an amount of thermal shrinkage is increased, and the Young's modulus is decreased, so that the glass disk is likely to be bent. On the other hand, when a content of Al₂O₃ is too large, buffered hydrofluoric acid (BHF) resistance is decreased, a glass surface is likely to be clouded, and crack resistance is likely to be decreased. Further, SiO₂—Al₂O₃-based crystals, particularly mullite, are precipitated in a glass, and the liquidus viscosity is likely to be decreased. An upper limit content of Al₂O₃ is suitably 16%, 15.5%, 15%, 14.5%, and particularly 14%, and a lower limit content is suitably 10%, 10.5%, 11%, 11.5%, and particularly 12%. A most preferred content range is 12% to 14%.

B₂O₃ is a component that acts as a flux, reduces a viscosity, and increases the meltability. When a content of B₂O₃ is too small, B₂O₃ does not sufficiently act as a flux, and the BHF resistance and the crack resistance are likely to be decreased. Further, a liquidus temperature is likely to rise. On the other hand, when a content of B₂O₃ is too large, the strain point, heat resistance, and the acid resistance are likely to be decreased, and particularly, the strain point is likely to be decreased. The glass is likely to be phase-separated. An upper limit content of B₂O₃ is suitably 5% and particularly 4.5%, and a lower limit content is suitably 0%, 1%, 1.5%, 2%, and particularly 2.5%. A most preferred content range is 2.5% to 4.5%.

Since alkali metal oxides (Li₂O, Na₂O, and K₂O) deteriorate properties of a magnetic film formed on the glass disk, a content of each of the alkali metal oxides is preferably reduced to 0.1% (desirably 0.06%, 0.05%, 0.02%, and particularly 0.01%).

MgO is a component that decreases the viscosity in high temperature without decreasing the strain point and improves the meltability. In addition, MgO has an effect of decreasing a density most in RO, but when MgO is excessively introduced, the SiO₂-based crystals, particularly the cristobalite, are precipitated, and the liquidus viscosity is likely to be decreased. Further, MgO is a component that easily reacts with BHF to form a product. The reaction product may be fixed or attached to the glass surface, which may make the glass cloudy. Further, impurities such as Fe₂O₃ may be mixed into the glass from a raw material for introducing MgO such as dolomite, and a transmittance of the glass disk may be reduced. Therefore, an upper limit content of MgO is suitably 12%, 11.5%, 11%, 10.5%, 10%, 9.5%, 9.3%, 9%, 8.5%, 8%, 7.5%, 7%, 6.5%, and particularly 6%, and a lower limit content is suitably 0%, 1%, 1.5%, 2%, 2.5%, 3%, 3.5%, 4%, and particularly 4.5%. A most preferred content range is 4.5% to 6%.

Similar to MgO, CaO is a component that decreases the viscosity in high temperature without decreasing the strain point and remarkably improves the meltability. However, when a content of CaO is too large, SiO₂—Al₂O₃—RO-based crystals, particularly anorthite, are precipitated, the liquidus viscosity is likely to be decreased, the BHF resistance is decreased, and a reaction product is fixed or attached to the glass surface, which may make the glass cloudy. Therefore, an upper limit content of CaO is suitably 12%, 11.5%, 11%, 10.5%, 10%, 9.5%, 9%, and particularly 8.5%, and a lower limit content is suitably 0%, 1%, 2%, 3%, 3.5%, 4%, 4.5%, 5%, 5.5%, 5.6%, 6%, and particularly 6.5%. A most preferred content range is 6.5% to 8.5%.

SrO is a component that increases the chemical resistance and devitrification resistance, but when a ratio thereof is excessively increased in the entire RO, the meltability is likely to be decreased, and the density and a thermal expansion coefficient are likely to be increased. Therefore, a content of SrO is preferably 0% to 10%, 0% to 9%, 0% to 8%, 0% to 7%, 0% to 6%, and particularly 0% to 5%.

BaO is a component that increases the chemical resistance and the devitrification resistance, but when a content thereof is too large, the density is likely to be increased. A SiO₂—Al₂O₃—B₂O₃—RO-based glass is generally difficult to melt, and thus it is very important to increase meltability and reduce a defective rate due to bubbles, foreign substances, and the like from a viewpoint of supplying a high-quality glass disk at a low cost and in a large amount. However, BaO has a poor effect of increasing the meltability in RO. Therefore, an upper limit content of BaO is suitably 10%, 9%, 8%, 7%, 6%, and particularly 5%, and a lower limit content thereof is suitably 0%, 0.1%, 0.3%, and particularly 0.2%.

SnO₂ has a function as a fining agent for reducing bubbles in the glass. On the other hand, when a content of SnO₂ is too large, devitrified crystals of SnO₂ are likely to be generated in the glass. An upper limit content of SnO₂ is suitably 1%, 0.5%, 0.4%, and particularly 0.3%, and a lower limit content is suitably 0%, 0.01%, 0.03%, and particularly 0.05%. A most preferred content range is 0.05% to 0.3%.

ZrO₂ is a component that increases chemical durability, but when an introduction amount thereof is large, crystals of ZrSiO₄ are likely to be generated. An upper limit content of ZrO₂ is suitably 1%, 0.5%, 0.3%, 0.2%, and particularly 0.1%, and it is preferable to introduce ZrO₂ in an amount of 0.001%% or more from a viewpoint of chemical durability. A most preferred content range is 0.001% to 0.1%. ZrO₂ may be introduced from a raw material or may be introduced by extraction from a refractory.

In addition to the above components, other components may be introduced. An introduction amount thereof is preferably 5% or less, 3% or less, and particularly 1% or less.

ZnO is a component that improves the meltability and the BHF resistance, but when a content thereof is too large, the glass is likely to devitrify or the strain point is decreased, so that it is difficult to secure the heat resistance. Therefore, a content of ZnO is preferably 0% to 10%, 0% to 5%, 0% to 3%, 0% to 2%, and particularly 0% to 1%.

P₂O₅ is a component that decreases a liquidus temperature of SiO₂—Al₂O₃—CaO-based crystals (particularly, anorthite) and SiO₂—Al₂O₃-based crystals (particularly, mullite). However, when a large amount of P₂O₅ is introduced, the glass is likely to be phase-separated. Therefore, a content of P₂O₅ is preferably 0% to 10%, 0% to 5%, 0% to 3%, 0% to 2%, 0% to 1%, and particularly 0% to 0.1%.

TiO₂ is a component that decreases the viscosity in high temperature and increases the meltability, and is a component that increases the chemical durability, but when TiO₂ is excessively introduced, an ultraviolet transmittance is likely to be decreased. A content of TiO₂ is preferably 3% or less, 1% or less, 0.5% or less, 0.1% or less, 0.05% or less, 0.03%, and particularly 0.01% or less. When a very small amount of TiO₂ is introduced (for example, 0.0001% or more), an effect of preventing coloring due to ultraviolet rays is obtained. A most preferred content range is 0.0001% to 0.01%.

As₂O₃ and Sb₂O₃ are components that act as fining agents, but are environmentally hazardous chemical substances, and thus it is desirable not to use As₂O₃ and Sb₂O₃ as much as possible. A content of each of As₂O₃ and Sb₂O₃ is preferably less than 0.3%, less than 0.1%, less than 0.09%, less than 0.05%, less than 0.03%, less than 0.01%, less than 0.005%, and particularly less than 0.003%.

Fe is a component mixed from a raw material as an impurity, but when a content of Fe is too large, the ultraviolet transmittance may be decreased. Therefore, a lower limit content of Fe is suitably 0.0001%, 0.0005%, 0.001%, and particularly 0.0015% in terms of Fe₂O₃, and an upper limit content is suitably 0.01%, 0.009%, 0.008%, 0.007%, and particularly 0.006% in terms of Fe₂O₃. A most preferred content range is 0.0015% to 0.006%.

Cr₂O₃ is a component mixed from a raw material as an impurity, but when a content of Cr₂O₃ is too large, in a case of performing foreign substance inspection of an inside of the glass disk with scattered light, transmission of light is difficult to occur, and a failure may occur in the foreign substance inspection. Particularly, when a substrate size is 730 mm×920 mm or more, this failure is likely to occur. When a thickness of the glass disk is small (for example, 0.5 mm or less, 0.4 mm or less, and particularly 0.3 mm or less), an amount of scattered light is decreased, and thus it is more meaningful to regulate a content of Cr₂O₃. An upper limit content of Cr₂O₃ is suitably 0.001%, 0.0008%, 0.0006%, 0.0005%, and particularly 0.0003%, and a lower limit content is suitably 0.00001%. A most preferred content range is 0.00001% to 0.0003%.

SO₃ is a component mixed from a raw material as an impurity, but when a content of SO₃ is too large, bubbles called reboil may be generated during melting or forming, which may cause defects in the glass. An upper limit content of SO₃ is suitably 0.005%, 0.003%, 0.002%, and particularly 0.001%, and a lower limit content is suitably 0.0001%. A most preferred content range is 0.0001% to 0.001%.

The glass disk for a magnetic recording medium of the present invention preferably has the following properties.

The glass disk for a magnetic recording medium is required to have an appropriate thermal expansion coefficient in order to enhance reliability of recording and reproduction of a magnetic recording medium. More specifically, a hard disk drive (HDD) incorporating the magnetic recording medium has a structure in which a central portion is pressed by a spindle of a spindle motor to rotate the magnetic recording medium itself. Therefore, when a difference in thermal expansion coefficient between the glass disk and a spindle material is too large, thermal expansion and thermal shrinkage of the glass disk and the spindle material are different from each other with respect to an ambient temperature change, and thus a phenomenon occurs in which the magnetic recording medium is deformed. When such a phenomenon occurs, written information cannot be read by a magnetic head, and the reliability of recording and reproduction may be impaired. Therefore, the glass disk for a magnetic recording medium desirably has a thermal expansion coefficient matching a thermal expansion coefficient of a spindle material (for example, stainless steel). From such a viewpoint, an average linear thermal expansion coefficient in a temperature range of 30° C. to 380° C. is preferably 25×10⁻⁷/° C. to 60×10⁻⁷/° C., 28×10⁻⁷/° C. to 55×10⁻⁷/° C., and particularly 30×10⁻⁷/° C. to 50×10⁻⁷/° C.

The liquidus temperature is preferably 1350° C. or lower, 1330° C. or lower, 1300° C. or lower, 1280° C. or lower, 1260° C. or lower, 1250° C. or lower, 1240° C. or lower, and particularly 1230° C. or lower. The liquidus viscosity is preferably 10^{3.8} dPa·s or more, 10^{4.4} dPa·s or more, 10^{4.6} dPa·s or more, 10^{4.8} dPa·s or more, and particularly 10^{5.0} dPa·s or more. Accordingly, devitrified crystals are less likely to be precipitated at the time of forming, and the glass is easily formed into a sheet shape by an overflow down-draw method or the like, and thus the average surface roughness Ra of the surface can be made 1.0 nm or less and particularly 0.2 nm or less without polishing the surface or by polishing a small amount. As a result, magnetic properties can be increased with miniaturization of a bit size. The cost of the glass disk can be reduced by reducing the devitrified crystals or an amount of polishing. Here, the term “liquidus temperature” can be calculated by putting a glass powder that passes through a standard sieve of 30 mesh (500 μm) and remains on a sieve of 50 mesh (300 μm) into a platinum boat, holding the platinum boat in a temperature gradient furnace for 24 hours, and measuring a temperature at which crystals are precipitated. The term “liquidus viscosity” refers to a viscosity of a glass at a liquidus temperature, and can be measured by a platinum sphere pull up method.

An average linear transmittance in an optical path length of 1 mm and a wavelength range of 350 nm to 1500 nm is preferably 70% or more, 80% or more, and particularly 90% or more. When the average linear transmittance in the optical path length of 1 mm and the wavelength range of 350 nm to 1500 nm is too low, the magnetic layer is not sufficiently irradiated with laser light at the time of laser irradiation, and it is difficult to achieve a high Ku of the magnetic layer.

The β-OH is preferably 0.30/mm or less, 0.25/mm or less, 0.20/mm or less, 0.15/mm or less, and particularly 0.10/mm or less. When β-OH is too large, an annealing point is likely to be decreased. When β-OH is too small, it is highly necessary to introduce a dry component such as chlorine, and in that case, chlorine and the like in the glass remain in a high state, which may increase an environmental load. Therefore, β-OH is preferably 0.01/mm or more, and particularly 0.02/mm or more.

Examples of a method for reducing β-OH include the following methods. (1) A raw material having a low water content is selected. (2) A component (Cl, SO₃, or the like) that reduces β-OH is added to the glass. (3) An amount of water in an atmosphere in a furnace is reduced. (4) N₂ bubbling is performed in a molten glass. (5) A small melting furnace is adopted. (6) A flow rate of the molten glass is increased. (7) An electric melting method is adopted.

Here, the term “δ-OH” refers to a value obtained, using the following equation, by measuring a transmittance of the glass disk using FT-IR.

β-OH=(1/X)log(T₁/T₂) [Equation 1]

X: thickness (mm)

T₁: transmittance (%) at a reference wavelength of 3846 cm⁻¹

T₂: minimum transmittance (%) at a hydroxy group absorption wavelength of around 3600 cm⁻¹

The average surface roughness Ra of the surface is preferably 1.0 nm or less, 0.7 nm or less, 0.4 nm or less, and particularly 0.2 nm or less. When the average surface roughness Ra of the surface is too large, improvement of the magnetic properties cannot be expected even if the bit size is miniaturized for a high recording density.

The thickness is preferably 1.5 mm or less, 1.2 mm or less, 0.2 mm to 1.0 mm, and particularly 0.3 mm to 0.9 mm. When the thickness is too large, polishing needs to be performed to a desired thickness, which may increase the processing cost.

A total thickness variation (TTV) is preferably less than 2.0 μm, 1.5 μm or less, 1.0 μm or less, and particularly 0.1 μm to less than 1.0 μm. When the total thickness variation (TTV) is too large, the improvement of the magnetic properties cannot be expected even if the bit size is miniaturized for the high recording density. Here, the term “total thickness variation (TTV)” is a difference between a maximum thickness and a minimum thickness of the entire glass disk, and can be measured by, for example, SBW-331ML/d manufactured by Kobelco Research Institute, Inc.

The entire surface of the glass disk for a magnetic recording medium of the present invention is preferably a polished surface. Accordingly, the total thickness variation (TTV) is likely to be regulated to less than 2.0 μm, 1.5 μm or less, 1.0 μm or less, and particularly less than 1.0 μm. As a method for a polishing treatment, various methods can be adopted, but a method of sandwiching both surfaces of the glass disk between a pair of polishing pads and performing the polishing treatment on the glass disk while rotating both the glass disk and the pair of polishing pads is preferred. Further, the pair of polishing pads preferably have different outer diameters, and the polishing treatment is preferably performed such that a part of the glass disk intermittently protrudes from the polishing pads at the time of polishing. Accordingly, the total thickness variation (TTV) is likely to be reduced, and an amount of warpage is also likely to be reduced. In the polishing treatment, a polishing depth is not particularly limited, and the polishing depth is preferably 50 μm or less, 30 μm or less, 20 μm or less, and particularly 10 μm or less. As the polishing depth is smaller, productivity of the glass disk is more improved.

The glass disk for a magnetic recording medium of the present invention can be produced, for example, by the following method. First, it is preferable that glass raw materials mixed so as to have a desired glass composition are put into a continuous melting furnace, heated and melted at 1500° C. to 1700° C., and fined, and then a molten glass is supplied to a forming device, formed into a sheet shape, and cooled. A known method can be adopted as a method of performing cutting into a disk shape after the forming into the sheet shape. As a method for forming a glass substrate, various methods can be adopted, and it is preferable to adopt an overflow down-draw method, a slot-down method, or the like in order to improve surface smoothness. It is possible to adopt, as appropriate, polishing of a disk surface for adjusting a thickness or TTV, drilling of a circular opening in a central portion of a disk, polishing of inner and outer peripheral end faces, forming of a magnetic layer on the disk surface, and the like.

### Example 1

Hereinafter, the present invention will be described based on Examples. The following Examples are merely illustrative. The present invention is not limited to the following Examples.

Tables 1 to 5 show Examples (Samples Nos. 1 to 131) of the present invention.

TABLE 1

| | | | No. 1 | No. 2 | No. 3 | No. 4 | No. 5 | No. 6 | No. 7 | No. 8 | No. 9 | No. 10 |
|---|---|---|---|---|---|---|---|---|---|---|---|---|
| Glass | SiO₂ | mol % | 67.32 | 67.97 | 67.34 | 64.92 | 64.87 | 64.75 | 65.86 | 65.80 | 65.87 | 66.80 |
| composi- | Al₂O₃ | mol % | 12.57 | 12.70 | 12.27 | 13.93 | 13.97 | 14.14 | 13.98 | 14.02 | 14.05 | 13.00 |
| tion | B₂O₃ | mol % | 3.00 | 3.00 | 2.80 | 3.98 | 3.99 | 4.04 | 3.01 | 3.02 | 3.05 | 3.05 |
| | Na₂O | mol % | 0.011 | 0.013 | 0.015 | 0.011 | 0.010 | 0.013 | 0.012 | 0.013 | 0.015 | 0.013 |
| | K₂O | mol % | 0.002 | 0.001 | 0.002 | 0.003 | 0.001 | 0.002 | 0.001 | 0.002 | 0.002 | 0.003 |
| | MgO | mol % | 6.02 | 5.69 | 7.01 | 6.04 | 5.05 | 4.94 | 6.04 | 5.04 | 4.93 | 7.07 |
| | CaO | mol % | 6.49 | 6.49 | 6.24 | 7.00 | 7.98 | 6.98 | 6.99 | 7.97 | 6.97 | 6.97 |
| | SrO | mol % | 2.02 | 1.43 | 1.23 | 2.02 | 2.03 | 2.52 | 2.02 | 2.03 | 2.51 | 1.47 |
| | BaO | mol % | 2.46 | 2.60 | 2.98 | 1.99 | 1.99 | 2.51 | 1.98 | 1.99 | 2.50 | 1.51 |
| | TiO₂ | mol % | 0.003 | 0.003 | 0.003 | 0.002 | 0.003 | 0.003 | 0.003 | 0.004 | 0.002 | 0.001 |
| | ZrO₂ | mol % | 0.003 | 0.005 | 0.011 | 0.005 | 0.003 | 0.004 | 0.005 | 0.008 | 0.010 | 0.011 |
| | SnO₂ | mol % | 0.090 | 0.089 | 0.089 | 0.090 | 0.090 | 0.091 | 0.090 | 0.090 | 0.091 | 0.088 |
| | Fe₂O₃ | mol % | 0.004 | 0.004 | 0.003 | 0.004 | 0.005 | 0.005 | 0.004 | 0.004 | 0.004 | 0.004 |

| | | | | | | | | | | | |
|---|---|---|---|---|---|---|---|---|---|---|---|
| β-OH | /mm | 0.15 | 0.15 | 0.14 | 0.18 | 0.18 | 0.18 | 0.15 | 0.15 | 0.15 | 0.15 |
| Density | g/cm³ | 2.569 | 2.575 | 2.593 | 2.585 | 2.587 | 2.608 | 2.589 | 2.592 | 2.613 | 2.559 |
| Thermal expansion | ×10⁻⁷/ | 38.2 | 37.8 | 38.9 | 38.9 | 39.7 | 39.8 | 38.7 | 39.6 | 40.0 | 38.0 |
| coefficient | ° C. | | | | | | | | | | |
| Young's modulus | GPa | 82.3 | 82.2 | 82.9 | 82.8 | 82.4 | 81.8 | 83.4 | 83.1 | 82.6 | 83.6 |
| Strain point | ° C. | 722 | 725 | 719 | 717 | 716 | 715 | 726 | 727 | 726 | 723 |
| Temperature at | ° C. | 1255 | 1260 | 1250 | 1226 | 1227 | 1231 | 1240 | 1240 | 1245 | 1243 |
| 10^{4.5} dPa · s | | | | | | | | | | | |
| Liquidus | ° C. | 1188 | 1191 | 1183 | 1177 | 1216 | 1205 | 1227 | 1247 | 1216 | 1199 |
| temperature | | | | | | | | | | | |
| Liquidus viscosity | dPa · s | 5.2 | 5.2 | 5.2 | 5.0 | 4.6 | 4.8 | 4.6 | 4.5 | 4.8 | 4.9 |
| (log η at TL) | | | | | | | | | | | |

TABLE 2

| | | | No. 11 | No. 12 | No. 13 | No. 14 | No. 15 | No. 16 | No. 17 | No. 18 | No. 19 | No. 20 |
|---|---|---|---|---|---|---|---|---|---|---|---|---|
| Glass | SiO₂ | mol % | 66.88 | 66.80 | 66.92 | 66.77 | 66.76 | 67.87 | 67.72 | 67.76 | 67.94 | 64.89 |
| composi- | Al₂O₃ | mol % | 13.04 | 13.00 | 13.00 | 13.02 | 13.01 | 12.02 | 12.02 | 11.98 | 11.98 | 13.97 |
| tion | B₂O₃ | mol % | 2.96 | 3.00 | 2.97 | 3.00 | 3.03 | 3.00 | 3.03 | 3.04 | 2.97 | 3.98 |
| | Na₂O | mol % | 0.011 | 0.011 | 0.011 | 0.012 | 0.012 | 0.013 | 0.015 | 0.011 | 0.014 | 0.013 |
| | K₂O | mol % | 0.002 | 0.001 | 0.002 | 0.001 | 0.002 | 0.003 | 0.001 | 0.002 | 0.002 | 0.001 |
| | MgO | mol % | 5.94 | 6.01 | 4.96 | 5.01 | 5.06 | 6.95 | 7.03 | 6.06 | 5.96 | 7.03 |
| | CaO | mol % | 8.06 | 6.96 | 9.03 | 8.05 | 7.04 | 8.02 | 7.05 | 8.01 | 7.02 | 6.02 |
| | SrO | mol % | 1.48 | 2.01 | 1.48 | 2.02 | 2.50 | 1.01 | 1.53 | 1.53 | 2.00 | 2.02 |
| | BaO | mol % | 1.52 | 2.11 | 1.52 | 2.02 | 2.48 | 1.02 | 1.50 | 1.51 | 2.00 | 1.98 |
| | TiO₂ | mol % | 0.004 | 0.003 | 0.003 | 0.002 | 0.003 | 0.002 | 0.002 | 0.001 | 0.002 | 0.001 |
| | ZrO₂ | mol % | 0.016 | 0.011 | 0.014 | 0.010 | 0.006 | 0.006 | 0.007 | 0.006 | 0.007 | 0.008 |
| | SnO₂ | mol % | 0.088 | 0.089 | 0.088 | 0.089 | 0.090 | 0.087 | 0.087 | 0.088 | 0.089 | 0.090 |
| | Fe₂O₃ | mol % | 0.004 | 0.004 | 0.005 | 0.005 | 0.005 | 0.005 | 0.006 | 0.005 | 0.004 | 0.004 |

| | | | | | | | | | | | |
|---|---|---|---|---|---|---|---|---|---|---|---|
| β-OH | /mm | 0.15 | 0.15 | 0.15 | 0.15 | 0.15 | 0.15 | 0.15 | 0.15 | 0.15 | 0.18 |
| Density | g/cm³ | 2.555 | 2.581 | 2.563 | 2.581 | 2.604 | 2.527 | 2.548 | 2.551 | 2.572 | 2.582 |
| Thermal expansion | ×10⁻⁷/ | 38.4 | 39.0 | 39.3 | 39.6 | 39.4 | 37.5 | 37.9 | 38.6 | 39.1 | 38.3 |
| coefficient | ° C. | | | | | | | | | | |
| Young's modulus | GPa | 83.7 | 83.0 | 83.2 | 82.4 | 82.2 | 83.7 | 83.3 | 82.8 | 82.7 | 83.2 |
| Strain point | ° C. | 722 | 721 | 721 | 720 | 720 | 717 | 716 | 717 | 715 | 718 |
| Temperature at | ° C. | 1243 | 1246 | 1244 | 1247 | 1250 | 1245 | 1247 | 1247 | 1253 | 1227 |
| 10^{4.5} dPa · s | | | | | | | | | | | |
| Liquidus | ° C. | 1208 | 1210 | 1239 | 1216 | 1211 | 1258 | 1222 | 1221 | 1234 | 1193 |
| temperature | | | | | | | | | | | |
| Liquidus viscosity | dPa · s | 4.8 | 4.9 | 4.6 | 4.8 | 4.9 | 4.5 | 4.7 | 4.7 | 4.7 | 4.8 |
| (log η at TL) | | | | | | | | | | | |

TABLE 3

| | | | No. 21 | No. 22 | No. 23 | No. 24 | No. 25 | No. 26 | No. 27 | No. 28 | No. 29 | No. 30 |
|---|---|---|---|---|---|---|---|---|---|---|---|---|
| Glass | SiO₂ | mol % | 64.90 | 64.88 | 65.75 | 65.80 | 65.85 | 65.76 | 65.86 | 66.83 | 66.86 | 66.80 |
| composi- | Al₂O₃ | mol % | 14.10 | 14.01 | 14.03 | 14.01 | 13.99 | 13.02 | 14.01 | 12.98 | 13.01 | 13.99 |
| tion | B₂O₃ | mol % | 3.93 | 4.05 | 3.00 | 3.04 | 2.98 | 3.01 | 3.99 | 4.03 | 3.97 | 3.01 |
| | Na₂O | mol % | 0.012 | 0.016 | 0.013 | 0.010 | 0.011 | 0.013 | 0.011 | 0.011 | 0.011 | 0.013 |
| | K₂O | mol % | 0.001 | 0.001 | 0.001 | 0.002 | 0.002 | 0.001 | 0.002 | 0.002 | 0.001 | 0.002 |
| | MgO | mol % | 5.95 | 5.96 | 7.03 | 5.93 | 4.98 | 7.05 | 6.05 | 5.97 | 6.01 | 6.04 |
| | CaO | mol % | 5.98 | 6.98 | 6.02 | 6.09 | 6.05 | 6.04 | 6.04 | 7.03 | 6.00 | 6.03 |
| | SrO | mol % | 2.51 | 0.00 | 2.02 | 2.51 | 3.01 | 2.48 | 1.96 | 1.03 | 2.01 | 2.02 |
| | BaO | mol % | 2.50 | 3.99 | 2.02 | 2.50 | 3.02 | 2.52 | 1.99 | 2.01 | 2.02 | 1.98 |
| | TiO₂ | mol % | 0.003 | 0.002 | 0.003 | 0.004 | 0.003 | 0.003 | 0.003 | 0.003 | 0.003 | 0.003 |
| | ZrO₂ | mol % | 0.010 | 0.013 | 0.013 | 0.011 | 0.006 | 0.005 | 0.011 | 0.005 | 0.003 | 0.004 |
| | SnO₂ | mol % | 0.091 | 0.091 | 0.090 | 0.091 | 0.092 | 0.090 | 0.090 | 0.089 | 0.089 | 0.090 |
| | Fe₂O₃ | mol % | 0.004 | 0.005 | 0.005 | 0.005 | 0.004 | 0.004 | 0.003 | 0.004 | 0.005 | 0.005 |

| | | | | | | | | | | | |
|---|---|---|---|---|---|---|---|---|---|---|---|
| β-OH | /mm | 0.18 | 0.18 | 0.15 | 0.15 | 0.14 | 0.15 | 0.18 | 0.18 | 0.18 | 0.15 |
| Density | g/cm³ | 2.603 | 2.609 | 2.586 | 2.610 | 2.633 | 2.612 | 2.571 | 2.549 | 2.564 | 2.576 |
| Thermal expansion | ×10⁻⁷/ | 39.3 | 39.0 | 38.2 | 39.3 | 40.4 | 40.1 | 37.6 | 37.4 | 37.8 | 37.4 |
| coefficient | ° C. | | | | | | | | | | |
| Young's modulus | GPa | 82.3 | 81.7 | 84.1 | 83.1 | 82.4 | 83.2 | 82.4 | 81.9 | 81.7 | 83.5 |
| Strain point | ° C. | 716 | 715 | 727 | 726 | 725 | 717 | 721 | 715 | 715 | 729 |
| Temperature at | ° C. | 1232 | 1228 | 1241 | 1247 | 1250 | 1235 | 1242 | 1241 | 1246 | 1261 |
| 10^{4.5} dPa · s | | | | | | | | | | | |
| Liquidus | ° C. | 1200 | 1186 | 1200 | 1205 | 1191 | 1222 | 1195 | 1223 | 1213 | 1219 |
| temperature | | | | | | | | | | | |
| Liquidus viscosity | dPa · s | 4.8 | 4.9 | 4.9 | 4.9 | 5.1 | 4.6 | 5.0 | 4.7 | 4.8 | 4.9 |
| (log η at TL) | | | | | | | | | | | |

TABLE 4

| | | | No. 31 | No. 32 | No. 33 | No. 34 | No. 35 | No. 36 | No. 37 | No. 38 | No. 39 | No. 40 |
|---|---|---|---|---|---|---|---|---|---|---|---|---|
| Glass | SiO₂ | mol % | 64.87 | 66.15 | 65.77 | 66.80 | 66.79 | 66.22 | 66.88 | 66.64 | 67.87 | 66.77 |
| composi- | Al₂O₃ | mol % | 13.99 | 13.84 | 14.00 | 14.03 | 14.00 | 14.51 | 14.03 | 14.04 | 12.99 | 14.03 |
| tion | B₂O₃ | mol % | 4.04 | 3.96 | 4.00 | 2.99 | 3.01 | 3.02 | 2.99 | 3.03 | 2.99 | 2.96 |
| | Na₂O | mol % | 0.012 | 0.013 | 0.011 | 0.013 | 0.011 | 0.011 | 0.011 | 0.012 | 0.011 | 0.013 |
| | K₂O | mol % | 0.001 | 0.002 | 0.002 | 0.003 | 0.002 | 0.001 | 0.002 | 0.001 | 0.002 | 0.003 |
| | MgO | mol % | 6.97 | 6.00 | 6.07 | 6.00 | 6.04 | 6.06 | 6.00 | 6.09 | 6.00 | 5.12 |
| | CaO | mol % | 5.99 | 6.95 | 6.06 | 7.07 | 6.03 | 6.05 | 5.99 | 6.08 | 5.99 | 6.01 |
| | SrO | mol % | 0.00 | 0.97 | 1.51 | 0.97 | 2.02 | 2.03 | 2.98 | 0.99 | 2.01 | 1.99 |
| | BaO | mol % | 4.02 | 2.02 | 2.48 | 2.02 | 1.98 | 1.99 | 1.01 | 3.02 | 2.02 | 3.00 |
| | TiO₂ | mol % | 0.003 | 0.004 | 0.002 | 0.003 | 0.004 | 0.003 | 0.003 | 0.002 | 0.003 | 0.003 |
| | ZrO₂ | mol % | 0.006 | 0.008 | 0.010 | 0.011 | 0.016 | 0.011 | 0.014 | 0.010 | 0.005 | 0.007 |
| | SnO₂ | mol % | 0.091 | 0.089 | 0.090 | 0.089 | 0.090 | 0.090 | 0.089 | 0.090 | 0.089 | 0.091 |
| | Fe₂O₃ | mol % | 0.004 | 0.004 | 0.004 | 0.004 | 0.004 | 0.004 | 0.005 | 0.005 | 0.005 | 0.006 |

| | | | | | | | | | | | |
|---|---|---|---|---|---|---|---|---|---|---|---|
| β-OH | /mm | 0.18 | 0.18 | 0.18 | 0.15 | 0.15 | 0.15 | 0.15 | 0.15 | 0.15 | 0.14 |
| Density | g/cm³ | 2.608 | 2.557 | 2.577 | 2.563 | 2.576 | 2.581 | 2.563 | 2.589 | 2.567 | 2.606 |
| Thermal expansion | ×10⁻⁷/ | 38.6 | 37.2 | 37.7 | 37.2 | 37.2 | 37.0 | 37.1 | 37.2 | 37.3 | 38.5 |
| coefficient | ° C. | | | | | | | | | | |
| Young's modulus | GPa | 82.9 | 83.1 | 82.8 | 84.0 | 83.6 | 84.1 | 83.9 | 83.3 | 82.8 | 82.6 |
| Strain point | ° C. | 716 | 719 | 719 | 730 | 731 | 733 | 733 | 733 | 727 | 730 |
| Temperature at | ° C. | 1230 | 1235 | 1238 | 1252 | 1254 | 1251 | 1253 | 1258 | 1260 | 1259 |
| 10^{4.5} dPa · s | | | | | | | | | | | |
| Liquidus | ° C. | 1207 | 1192 | 1189 | 1221 | 1202 | 1239 | 1214 | 1208 | 1188 | 1204 |
| temperature | | | | | | | | | | | |
| Liquidus viscosity | dPa · s | 4.7 | 4.9 | 5.0 | 4.8 | 5.0 | 4.6 | 4.9 | 5.0 | 5.2 | 5.0 |
| (log η at TL) | | | | | | | | | | | |

TABLE 5

| | | | No. 41 | No. 42 | No. 43 | No. 44 | No. 45 | No. 46 | No. 47 | No. 48 | No. 49 | No. 50 |
|---|---|---|---|---|---|---|---|---|---|---|---|---|
| Glass | SiO₂ | mol % | 67.14 | 67.65 | 67.78 | 66.85 | 67.06 | 67.33 | 67.21 | 67.37 | 67.88 | 67.88 |
| composi- | Al₂O₃ | mol % | 12.18 | 13.03 | 13.01 | 13.03 | 13.47 | 13.02 | 12.19 | 12.59 | 12.70 | 13.00 |
| tion | B₂O₃ | mol % | 2.91 | 3.03 | 2.93 | 4.05 | 2.93 | 2.93 | 2.86 | 2.99 | 3.00 | 3.00 |
| | Na₂O | mol % | 0.011 | 0.011 | 0.014 | 0.013 | 0.012 | 0.011 | 0.013 | 0.010 | 0.011 | 0.011 |
| | K₂O | mol % | 0.001 | 0.002 | 0.002 | 0.001 | 0.001 | 0.001 | 0.001 | 0.002 | 0.002 | 0.002 |
| | MgO | mol % | 6.87 | 5.07 | 5.57 | 5.99 | 5.57 | 5.06 | 6.93 | 6.00 | 6.00 | 5.70 |
| | CaO | mol % | 6.26 | 6.56 | 6.55 | 6.46 | 6.55 | 6.55 | 7.23 | 6.59 | 6.30 | 6.30 |
| | SrO | mol % | 1.30 | 1.51 | 0.53 | 1.49 | 1.51 | 2.50 | 1.28 | 2.33 | 1.70 | 1.40 |
| | BaO | mol % | 3.21 | 3.02 | 3.51 | 2.01 | 2.79 | 2.49 | 2.17 | 2.02 | 2.30 | 2.60 |
| | TiO₂ | mol % | 0.002 | 0.003 | 0.002 | 0.003 | 0.003 | 0.002 | 0.003 | 0.003 | 0.003 | 0.003 |
| | ZrO₂ | mol % | 0.008 | 0.007 | 0.007 | 0.008 | 0.010 | 0.013 | 0.013 | 0.011 | 0.005 | 0.005 |
| | SnO₂ | mol % | 0.090 | 0.090 | 0.090 | 0.089 | 0.090 | 0.090 | 0.088 | 0.089 | 0.089 | 0.090 |
| | Fe₂O₃ | mol % | 0.006 | 0.005 | 0.004 | 0.004 | 0.004 | 0.005 | 0.005 | 0.005 | 0.004 | 0.004 |

| | | | | | | | | | | | |
|---|---|---|---|---|---|---|---|---|---|---|---|
| β-OH | /mm | 0.14 | 0.15 | 0.14 | 0.18 | 0.14 | 0.14 | 0.14 | 0.15 | 0.15 | 0.15 |
| Density | g/cm³ | 2.596 | 2.590 | 2.588 | 2.554 | 2.592 | 2.619 | 2.574 | 2.561 | 2.572 | 2.569 |
| Thermal expansion | ×10⁻⁷/ | 38.8 | 38.5 | 38.1 | 37.5 | 38.4 | 40.4 | 39.1 | 37.7 | 38.1 | 37.3 |
| coefficient | ° C. | | | | | | | | | | |
| Young's modulus | GPa | 82.4 | 82.0 | 82.1 | 82.1 | 82.9 | 82.0 | 83.4 | 82.4 | 82.5 | 81.7 |
| Strain point | ° C. | 718 | 726 | 727 | 717 | 728 | 721 | 717 | 726 | 723 | 728 |
| Temperature at | ° C. | 1250 | 1263 | 1262 | 1244 | 1256 | 1251 | 1241 | 1258 | 1256 | 1266 |
| 10^{4.5} dPa · s | | | | | | | | | | | |
| Liquidus | ° C. | 1158 | 1202 | 1181 | 1173 | 1200 | 1227 | 1192 | 1201 | 1196 | 1207 |
| temperature | | | | | | | | | | | |
| Liquidus viscosity | dPa · s | 5.4 | 5.1 | 5.3 | 5.2 | 5.1 | 4.7 | 5.0 | 5.1 | 5.1 | 5.1 |
| (log η at TL) | | | | | | | | | | | |

TABLE 6

| | | | No. 51 | No. 52 | No. 53 | No. 54 | No. 55 | No. 56 | No. 57 | No. 58 | No. 59 | No. 60 |
|---|---|---|---|---|---|---|---|---|---|---|---|---|
| Glass | SiO₂ | mol % | 67.52 | 65.92 | 65.78 | 65.96 | 65.74 | 66.00 | 65.80 | 66.04 | 65.68 | 65.88 |
| composi- | Al₂O₃ | mol % | 13.11 | 14.93 | 14.90 | 14.95 | 14.99 | 14.84 | 14.98 | 14.86 | 15.17 | 14.97 |
| tion | B₂O₃ | mol % | 3.30 | 2.03 | 2.15 | 1.96 | 2.09 | 2.01 | 2.09 | 2.02 | 2.03 | 1.96 |
| | Na₂O | mol % | 0.007 | 0.020 | 0.020 | 0.013 | 0.016 | 0.023 | 0.014 | 0.016 | 0.015 | 0.020 |
| | K₂O | mol % | 0.000 | 0.003 | 0.002 | 0.002 | 0.001 | 0.002 | 0.002 | 0.001 | 0.002 | 0.002 |
| | MgO | mol % | 6.16 | 6.94 | 6.95 | 6.97 | 6.97 | 6.94 | 7.96 | 7.92 | 7.94 | 7.98 |
| | CaO | mol % | 6.50 | 6.05 | 6.10 | 4.06 | 4.10 | 4.10 | 6.04 | 6.05 | 4.05 | 4.08 |
| | SrO | mol % | 1.59 | 3.01 | 1.01 | 4.99 | 3.01 | 1.01 | 3.00 | 1.02 | 4.98 | 3.02 |
| | BaO | mol % | 1.69 | 0.99 | 2.98 | 1.00 | 2.99 | 4.98 | 0.03 | 1.97 | 0.04 | 2.00 |
| | TiO₂ | mol % | 0.003 | 0.007 | 0.007 | 0.006 | 0.007 | 0.009 | 0.007 | 0.007 | 0.006 | 0.007 |
| | ZrO₂ | mol % | 0.010 | 0.001 | 0.001 | 0.001 | 0.001 | 0.002 | 0.001 | 0.001 | 0.001 | 0.001 |
| | SnO₂ | mol % | 0.096 | 0.080 | 0.086 | 0.082 | 0.087 | 0.084 | 0.079 | 0.085 | 0.080 | 0.086 |
| | Fe₂O₃ | mol % | 0.003 | 0.007 | 0.007 | 0.007 | 0.006 | 0.007 | 0.007 | 0.007 | 0.007 | 0.007 |

| | | | | | | | | | | | |
|---|---|---|---|---|---|---|---|---|---|---|---|
| β-OH | /mm | 0.10 | 0.14 | 0.14 | 0.14 | 0.15 | 0.15 | 0.15 | 0.13 | 0.13 | 0.15 |
| Density | g/cm³ | 2.549 | 2.586 | 2.614 | 2.616 | 2.644 | 2.669 | 2.558 | 2.583 | 2.590 | 2.613 |
| Thermal expansion | ×10⁻⁷/ | 37.1 | 37.6 | 37.9 | 38.1 | 38.4 | 38.7 | 36.4 | 36.7 | 36.9 | 37.2 |
| coefficient | ° C. | | | | | | | | | | |
| Young's modulus | GPa | 83.0 | 85.7 | 85.1 | 85.2 | 84.4 | 83.7 | 86.9 | 86.2 | 86.6 | 85.6 |
| Strain point | ° C. | 725 | 741 | 740 | 741 | 740 | 740 | 741 | 741 | 742 | 740 |
| Temperature at | ° C. | 1255 | 1247 | 1250 | 1250 | 1255 | 1255 | 1241 | 1242 | 1249 | 1249 |
| 10^{4.5} dPa · s | | | | | | | | | | | |
| Liquidus | ° C. | 1184 | 1265 | 1256 | 1269 | 1253 | 1227 | 1295 | 1282 | 1294 | 1285 |
| temperature | | | | | | | | | | | |
| Liquidus viscosity | dPa · s | 5.2 | 4.3 | 4.5 | 4.3 | 4.5 | 4.8 | 4.0 | 4.1 | 4.1 | 4.2 |
| (log η at TL) | | | | | | | | | | | |

TABLE 7

| | | | No. 61 | No. 62 | No. 63 | No. 64 | No. 65 | No. 66 | No. 67 | No. 68 | No. 69 | No. 70 |
|---|---|---|---|---|---|---|---|---|---|---|---|---|
| Glass | SiO₂ | mol % | 65.85 | 66.01 | 66.01 | 66.90 | 66.90 | 68.68 | 68.79 | 68.76 | 68.83 | 68.86 |
| composi- | Al₂O₃ | mol % | 14.87 | 13.97 | 13.99 | 13.97 | 14.02 | 13.60 | 13.53 | 13.53 | 13.57 | 13.53 |
| tion | B₂O₃ | mol % | 2.08 | 1.92 | 1.92 | 1.92 | 0.96 | 1.11 | 1.03 | 1.05 | 0.86 | 0.97 |
| | Na₂O | mol % | 0.018 | 0.027 | 0.017 | 0.015 | 0.015 | 0.017 | 0.014 | 0.016 | 0.014 | 0.012 |
| | K₂O | mol % | 0.001 | 0.002 | 0.001 | 0.001 | 0.001 | 0.001 | 0.001 | 0.001 | 0.001 | 0.001 |
| | MgO | mol % | 7.97 | 6.95 | 7.94 | 7.04 | 6.94 | 6.96 | 6.96 | 6.98 | 6.99 | 6.98 |
| | CaO | mol % | 4.11 | 7.01 | 6.03 | 6.04 | 7.04 | 9.00 | 7.02 | 7.06 | 5.05 | 5.05 |
| | SrO | mol % | 1.02 | 3.00 | 3.00 | 3.01 | 3.02 | 0.52 | 2.52 | 0.51 | 4.52 | 2.51 |
| | BaO | mol % | 3.98 | 1.00 | 1.00 | 1.00 | 1.00 | 0.00 | 0.03 | 1.99 | 0.06 | 2.00 |
| | TiO₂ | mol % | 0.007 | 0.006 | 0.006 | 0.006 | 0.006 | 0.010 | 0.009 | 0.007 | 0.007 | 0.008 |
| | ZrO₂ | mol % | 0.001 | 0.001 | 0.001 | 0.001 | 0.001 | 0.002 | 0.001 | 0.001 | 0.001 | 0.001 |
| | SnO₂ | mol % | 0.087 | 0.080 | 0.080 | 0.080 | 0.093 | 0.086 | 0.082 | 0.088 | 0.084 | 0.085 |
| | Fe₂O₃ | mol % | 0.007 | 0.007 | 0.007 | 0.007 | 0.007 | 0.008 | 0.008 | 0.007 | 0.007 | 0.007 |

| | | | | | | | | | | | |
|---|---|---|---|---|---|---|---|---|---|---|---|
| β-OH | /mm | 0.13 | 0.13 | 0.14 | 0.14 | 0.14 | 0.15 | 0.15 | 0.15 | 0.14 | 0.14 |
| Density | g/cm³ | 2.640 | 2.590 | 2.588 | 2.579 | 2.597 | 2.507 | 2.538 | 2.564 | 2.569 | 2.592 |
| Thermal expansion | ×10⁻⁷/ | 37.5 | 39.4 | 38.6 | 37.8 | 39.2 | 35.8 | 36.3 | 36.6 | 36.8 | 37.1 |
| coefficient | ° C. | | | | | | | | | | |
| Young's modulus | GPa | 84.9 | 85.5 | 86.0 | 85.3 | 86.5 | 86.9 | 86.3 | 85.5 | 85.7 | 85.1 |
| Strain point | ° C. | 740 | 733 | 733 | 737 | 744 | 753 | 750 | 750 | 750 | 749 |
| Temperature at | ° C. | 1254 | 1239 | 1239 | 1250 | 1253 | 1268 | 1273 | 1277 | 1279 | 1283 |
| 10^{4.5} dPa · s | | | | | | | | | | | |
| Liquidus | ° C. | 1282 | 1243 | 1245 | 1222 | 1266 | 1282 | 1263 | 1273 | 1259 | 1262 |
| temperature | | | | | | | | | | | |
| Liquidus viscosity | dPa · s | 4.2 | 4.5 | 4.5 | 4.8 | 4.4 | 4.4 | 4.6 | 4.5 | 4.7 | 4.7 |
| (log η at TL) | | | | | | | | | | | |

TABLE 8

| | | | No. 71 | No. 72 | No. 73 | No. 74 | No. 75 | No. 76 | No. 77 | No. 78 | No. 79 | No. 80 |
|---|---|---|---|---|---|---|---|---|---|---|---|---|
| Glass | SiO₂ | mol % | 68.75 | 68.07 | 67.75 | 67.77 | 68.06 | 67.90 | 67.84 | 66.83 | 67.35 | 66.96 |
| composi- | Al₂O₃ | mol % | 13.55 | 13.41 | 13.57 | 13.55 | 13.50 | 13.49 | 13.51 | 13.37 | 13.36 | 13.44 |
| tion | B₂O₃ | mol % | 0.98 | 1.11 | 1.03 | 1.04 | 0.86 | 0.96 | 0.98 | 3.26 | 2.78 | 3.57 |
| | Na₂O | mol % | 0.012 | 0.015 | 0.015 | 0.013 | 0.015 | 0.013 | 0.012 | 0.020 | 0.017 | 0.030 |
| | K₂O | mol % | 0.001 | 0.001 | 0.001 | 0.001 | 0.001 | 0.001 | 0.001 | 0.002 | 0.002 | 0.002 |
| | MgO | mol % | 6.96 | 7.84 | 7.96 | 7.95 | 7.91 | 7.94 | 7.93 | 6.37 | 6.35 | 5.87 |
| | CaO | mol % | 5.11 | 8.93 | 7.02 | 7.05 | 5.03 | 5.06 | 5.11 | 6.54 | 6.54 | 6.54 |
| | SrO | mol % | 0.52 | 0.51 | 2.52 | 0.51 | 4.47 | 2.53 | 0.51 | 1.81 | 1.81 | 1.61 |
| | BaO | mol % | 4.02 | 0.01 | 0.03 | 2.00 | 0.06 | 2.00 | 4.01 | 1.70 | 1.70 | 1.90 |
| | TiO₂ | mol % | 0.009 | 0.007 | 0.007 | 0.007 | 0.007 | 0.008 | 0.009 | 0.006 | 0.006 | 0.006 |
| | ZrO₂ | mol % | 0.001 | 0.001 | 0.001 | 0.001 | 0.001 | 0.001 | 0.001 | 0.001 | 0.001 | 0.001 |
| | SnO₂ | mol % | 0.086 | 0.081 | 0.082 | 0.088 | 0.083 | 0.085 | 0.086 | 0.080 | 0.075 | 0.076 |
| | Fe₂O₃ | mol % | 0.007 | 0.008 | 0.008 | 0.007 | 0.007 | 0.008 | 0.007 | 0.008 | 0.007 | 0.007 |

| | | | | | | | | | | | |
|---|---|---|---|---|---|---|---|---|---|---|---|
| β-OH | /mm | 0.14 | 0.15 | 0.15 | 0.15 | 0.13 | 0.13 | 0.15 | 0.15 | 0.15 | 0.14 |
| Density | g/cm³ | 2.620 | 2.518 | 2.548 | 2.574 | 2.580 | 2.604 | 2.631 | 2.562 | 2.565 | 2.559 |
| Thermal expansion | ×10⁻⁷/ | 37.4 | 36.6 | 37.1 | 37.4 | 37.6 | 37.9 | 38.2 | 37.6 | 37.5 | 37.3 |
| coefficient | ° C. | | | | | | | | | | |
| Young's modulus | GPa | 84.5 | 87.7 | 87.2 | 86.5 | 86.5 | 85.8 | 85.1 | 83.5 | 84.0 | 82.9 |
| Strain point | ° C. | 750 | 747 | 747 | 745 | 747 | 745 | 746 | 724 | 730 | 723 |
| Temperature at | ° C. | 1287 | 1254 | 1257 | 1261 | 1259 | 1273 | 1271 | 1247 | 1256 | 1252 |
| 10^{4.5} dPa · s | | | | | | | | | | | |
| Liquidus | ° C. | 1262.0 | 1255 | 1243 | 1280 | 1273 | 1267 | 1278 | 1202 | 1207 | 1190 |
| temperature | | | | | | | | | | | |
| Liquidus viscosity | dPa · s | 4.7 | 4.5 | 4.6 | 4.3 | 4.4 | 4.5 | 4.4 | 4.9 | 5.0 | 5.1 |
| (log η at TL) | | | | | | | | | | | |

TABLE 9

| | | | No. 81 | No. 82 | No. 83 | No. 84 | No. 85 | No. 86 | No. 87 | No. 88 | No. 89 | No. 90 |
|---|---|---|---|---|---|---|---|---|---|---|---|---|
| Glass | SiO₂ | mol % | 67.22 | 67.59 | 67.61 | 67.28 | 67.59 | 67.55 | 67.60 | 67.54 | 67.63 | 67.29 |
| composi- | Al₂O₃ | mol % | 13.42 | 12.62 | 12.85 | 13.78 | 13.73 | 13.53 | 13.71 | 13.52 | 13.50 | 13.54 |
| tion | B₂O₃ | mol % | 3.28 | 3.16 | 3.06 | 1.52 | 1.51 | 1.51 | 1.51 | 1.50 | 1.41 | 1.50 |
| | Na₂O | mol % | 0.024 | 0.027 | 0.016 | 0.030 | 0.024 | 0.023 | 0.020 | 0.032 | 0.020 | 0.018 |
| | K₂O | mol % | 0.004 | 0.004 | 0.002 | 0.005 | 0.004 | 0.005 | 0.004 | 0.003 | 0.003 | 0.003 |
| | MgO | mol % | 5.74 | 6.45 | 6.45 | 7.53 | 7.53 | 75.3 | 7.52 | 7.52 | 7.80 | 7.79 |
| | CaO | mol % | 6.64 | 6.54 | 6.63 | 6.52 | 6.52 | 6.52 | 6.52 | 7.00 | 7.01 | 7.01 |
| | SrO | mol % | 1.61 | 1.51 | 1.60 | 2.76 | 2.75 | 2.99 | 3.00 | 2.74 | 2.50 | 2.49 |
| | BaO | mol % | 1.89 | 2.00 | 1.70 | 0.50 | 0.25 | 0.25 | 0.03 | 0.03 | 0.03 | 0.25 |
| | TiO₂ | mol % | 0.007 | 0.007 | 0.007 | 0.007 | 0.007 | 0.006 | 0.007 | 0.007 | 0.017 | 0.007 |
| | ZrO₂ | mol % | 0.001 | 0.001 | 0.001 | 0.001 | 0.001 | 0.001 | 0.001 | 0.001 | 0.001 | 0.001 |
| | SnO₂ | mol % | 0.080 | 0.075 | 0.079 | 0.079 | 0.078 | 0.078 | 0.078 | 0.078 | 0.078 | 0.082 |
| | Fe₂O₃ | mol % | 0.071 | 0.007 | 0.007 | 0.007 | 0.007 | 0.008 | 0.008 | 0.008 | 0.008 | 0.008 |

| | | | | | | | | | | | |
|---|---|---|---|---|---|---|---|---|---|---|---|
| β-OH | /mm | 0.14 | 0.14 | 0.14 | 0.14 | 0.15 | 0.15 | 0.15 | 0.14 | 0.14 | 0.14 |
| Density | g/cm³ | 2.560 | 2.559 | 2.555 | 2.563 | 2.554 | 2.558 | 2.551 | 2.548 | 2.544 | 2.554 |
| Thermal expansion | ×10⁻⁷/ | 37.3 | 37.9 | 37.6 | 37.5 | 37.0 | 37.5 | 37.0 | 37.4 | 37.1 | 37.6 |
| coefficient | ° C. | | | | | | | | | | |
| Young's modulus | GPa | 83.1 | 82.4 | 83.0 | 86.2 | 86.4 | 86.2 | 86.6 | 86.5 | 86.6 | 86.6 |
| Strain point | ° C. | 726 | 719 | 724 | 739 | 741 | 738 | 741 | 738 | 739 | 738 |
| Temperature at | ° C. | 1256 | 1250 | 1252 | 1254 | 1257 | 1256 | 1255 | 1255 | 1253 | 1251 |
| 10^{4.5} dPa · s | | | | | | | | | | | |
| Liquidus | ° C. | 1200 | 1184 | 1196 | 1240 | 1255 | 1240 | 1246 | 1239 | 1247 | 1246 |
| temperature | | | | | | | | | | | |
| Liquidus viscosity | dPa · s | 5.0 | 5.2 | 5.1 | 4.6 | 4.5 | 4.7 | 4.6 | 4.7 | 4.6 | 4.6 |
| (log η at TL) | | | | | | | | | | | |

TABLE 10

| | | | No. 91 | No. 92 | No. 93 | No. 94 | No. 95 | No. 96 | No. 97 | No. 98 | No. 99 | No. 100 |
|---|---|---|---|---|---|---|---|---|---|---|---|---|
| Glass | SiO₂ | mol % | 67.63 | 67.49 | 67.50 | 67.48 | 67.33 | 67.64 | 67.81 | 67.62 | 67.72 | 67.33 |
| composi- | Al₂O₃ | mol % | 13.52 | 13.38 | 13.35 | 13.37 | 13.37 | 13.35 | 12.75 | 12.87 | 12.85 | 13.39 |
| tion | B₂O₃ | mol % | 1.41 | 3.17 | 3.17 | 3.21 | 3.19 | 3.21 | 3.21 | 3.23 | 3.18 | 3.17 |
| | Na₂O | mol % | 0.016 | 0.015 | 0.015 | 0.014 | 0.014 | 0.014 | 0.014 | 0.013 | 0.014 | 0.014 |
| | K₂O | mol % | 0.003 | 0.001 | 0.001 | 0.001 | 0.001 | 0.001 | 0.001 | 0.001 | 0.001 | 0.001 |
| | MgO | mol % | 7.54 | 5.67 | 5.75 | 5.85 | 5.86 | 5.63 | 6.34 | 6.33 | 6.34 | 6.14 |
| | CaO | mol % | 6.78 | 6.55 | 6.59 | 6.55 | 6.60 | 6.53 | 6.56 | 6.53 | 6.57 | 6.52 |
| | SrO | mol % | 2.76 | 1.62 | 1.52 | 1.62 | 1.63 | 1.62 | 1.42 | 1.52 | 1.42 | 1.63 |
| | BaO | mol % | 0.25 | 2.01 | 2.01 | 1.81 | 1.91 | 1.91 | 1.80 | 1.80 | 1.81 | 1.71 |
| | TiO₂ | mol % | 0.01 | 0.01 | 0.01 | 0.01 | 0.01 | 0.01 | 0.01 | 0.01 | 0.01 | 0.01 |
| | ZrO₂ | mol % | 0.00 | 0.00 | 0.00 | 0.00 | 0.00 | 0.00 | 0.00 | 0.00 | 0.00 | 0.00 |
| | SnO₂ | mol % | 0.08 | 0.08 | 0.08 | 0.08 | 0.08 | 0.08 | 0.08 | 0.08 | 0.08 | 0.08 |
| | Fe₂O₃ | mol % | 0.01 | 0.01 | 0.01 | 0.01 | 0.01 | 0.01 | 0.01 | 0.01 | 0.01 | 0.01 |

| | | | | | | | | | | | |
|---|---|---|---|---|---|---|---|---|---|---|---|
| β-OH | /mm | 0.15 | 0.15 | 0.15 | 0.13 | 0.13 | 0.15 | 0.13 | 0.13 | 0.14 | 0.14 |
| Density | g/cm³ | 2.555 | 2.561 | 2.559 | 2.555 | 2.559 | 2.556 | 2.549 | 2.552 | 2.550 | 2.552 |
| Thermal expansion | ×10⁻⁷/ | 37.5 | 37.3 | 37.2 | 37.1 | 37.3 | 37.1 | 37.2 | 37.4 | 37.2 | 37.1 |
| coefficient | ° C. | | | | | | | | | | |
| Young's modulus | GPa | 86.4 | 82.5 | 82.7 | 82.9 | 82.7 | 82.5 | 82.6 | 82.8 | 82.8 | 83.2 |
| Strain point | ° C. | 738 | 724 | 724 | 725 | 723 | 725 | 721 | 721 | 720 | 725 |
| Temperature at | ° C. | 1255 | 1259 | 1257 | 1256 | 1255 | 1257 | 1255 | 1252 | 1253 | 1255 |
| 10^{4.5} dPa · s | | | | | | | | | | | |
| Liquidus | ° C. | 1228 | 1199 | 1199 | 1198 | 1191 | 1201 | 1191 | 1196 | 1180 | 1212 |
| temperature | | | | | | | | | | | |
| Liquidus viscosity | dPa · s | 4.8 | 5.1 | 5.1 | 5.1 | 5.1 | 5.1 | 5.1 | 5.1 | 5.2 | 4.9 |
| (log η at TL) | | | | | | | | | | | |

TABLE 11

| | | | No. 101 | No. 102 | No. 103 | No. 104 | No. 105 | No. 106 | No. 107 | No. 108 | No. 109 | No. 110 |
|---|---|---|---|---|---|---|---|---|---|---|---|---|
| Glass | SiO₂ | mol % | 67.40 | 67.67 | 67.83 | 67.99 | 67.87 | 68.52 | 68.45 | 67.88 | 67.87 | 67.95 |
| composi- | Al₂O₃ | mol % | 13.08 | 13.33 | 13.35 | 13.50 | 13.49 | 13.50 | 13.50 | 13.50 | 13.42 | 13.51 |
| tion | B₂O₃ | mol % | 3.15 | 3.25 | 3.25 | 1.10 | 1.10 | 1.10 | 1.60 | 1.08 | 1.16 | 1.56 |
| | Na₂O | mol % | 0.014 | 0.018 | 0.015 | 0.017 | 0.012 | 0.017 | 0.013 | 0.031 | 0.018 | 0.017 |
| | K₂O | mol % | 0.001 | 0.003 | 0.004 | 0.007 | 0.001 | 0.007 | 0.001 | 0.007 | 0.003 | 0.003 |
| | MgO | mol % | 6.35 | 5.65 | 5.44 | 7.94 | 8.05 | 7.42 | 7.46 | 7.96 | 7.97 | 7.50 |
| | CaO | mol % | 6.56 | 6.55 | 6.57 | 8.94 | 8.96 | 8.93 | 8.46 | 9.04 | 9.06 | 8.94 |
| | SrO | mol % | 1.63 | 1.62 | 1.63 | 0.41 | 0.41 | 0.41 | 0.41 | 0.41 | 0.41 | 0.41 |
| | BaO | mol % | 1.70 | 1.80 | 1.80 | 0.00 | 0.00 | 0.00 | 0.00 | 0.00 | 0.00 | 0.01 |
| | TiO₂ | mol % | 0.007 | 0.007 | 0.006 | 0.008 | 0.007 | 0.008 | 0.008 | 0.007 | 0.007 | 0.007 |
| | ZrO₂ | mol % | 0.001 | 0.001 | 0.001 | 0.002 | 0.001 | 0.001 | 0.001 | 0.001 | 0.001 | 0.001 |
| | SnO₂ | mol % | 0.089 | 0.089 | 0.089 | 0.081 | 0.081 | 0.077 | 0.081 | 0.081 | 0.077 | 0.081 |
| | Fe₂O₃ | mol % | 0.007 | 0.007 | 0.007 | 0.009 | 0.009 | 0.009 | 0.008 | 0.009 | 0.009 | 0.009 |

| | | | | | | | | | | | |
|---|---|---|---|---|---|---|---|---|---|---|---|
| β-OH | /mm | 0.14 | 0.15 | 0.15 | 0.15 | 0.14 | 0.14 | 0.14 | 0.15 | 0.15 | 0.15 |
| Density | g/cm³ | 2.553 | 2.552 | 2.551 | 2.515 | 2.516 | 2.509 | 2.500 | 2.515 | 2.514 | 2.507 |
| Thermal expansion | ×10⁻⁷/ | 37.3 | 36.9 | 36.8 | 36.4 | 36.5 | 36.0 | 35.4 | 36.6 | 36.6 | 36.2 |
| coefficient | ° C. | | | | | | | | | | |
| Young's modulus | GPa | 83.0 | 82.8 | 82.6 | 87.8 | 87.9 | 87.5 | 87.0 | 87.6 | 87.6 | 87.1 |
| Strain point | ° C. | 722 | 723 | 725 | 747 | 747 | 749 | 746 | 747 | 745 | 743 |
| Temperature at | ° C. | 1249 | 1258 | 1263 | 1254 | 1254 | 1263 | 1262 | 1254 | 1253 | 1256 |
| 10^{4.5} dPa · s | | | | | | | | | | | |
| Liquidus | ° C. | 1194 | 1198 | 1181 | 1261 | 1265 | 1263 | 1257 | 1253 | 1255 | 1247 |
| temperature | | | | | | | | | | | |
| Liquidus viscosity | dPa · s | 5.0 | 5.1 | 5.3 | 4.4 | 4.4 | 4.5 | 4.6 | 4.5 | 4.5 | 4.6 |
| (log η at TL) | | | | | | | | | | | |

TABLE 12

| | | | No. 111 | No. 112 | No. 113 | No. 114 | No. 115 | No. 116 | No. 117 | No. 118 | No. 119 | No. 120 |
|---|---|---|---|---|---|---|---|---|---|---|---|---|
| Glass | SiO₂ | mol % | 68.15 | 70.34 | 68.79 | 68.72 | 67.27 | 67.29 | 67.33 | 65.79 | 65.81 | 68.78 |
| composi- | Al₂O₃ | mol % | 13.32 | 13.48 | 13.47 | 13.54 | 13.47 | 13.47 | 13.48 | 13.47 | 13.47 | 12.50 |
| tion | B₂O₃ | mol % | 1.57 | 0.00 | 0.00 | 0.00 | 0.00 | 0.00 | 0.00 | 0.00 | 0.00 | 0.00 |
| | Na₂O | mol % | 0.021 | 0.010 | 0.010 | 0.010 | 0.010 | 0.010 | 0.010 | 0.010 | 0.010 | 0.010 |
| | K₂O | mol % | 0.003 | 0.002 | 0.002 | 0.001 | 0.001 | 0.001 | 0.001 | 0.001 | 0.001 | 0.001 |
| | MgO | mol % | 7.47 | 7.52 | 9.07 | 7.57 | 10.60 | 9.06 | 7.52 | 10.58 | 9.07 | 9.53 |
| | CaO | mol % | 8.96 | 8.03 | 8.04 | 9.55 | 8.05 | 9.55 | 11.04 | 9.54 | 11.04 | 8.56 |
| | SrO | mol % | 0.41 | 0.51 | 0.51 | 0.51 | 0.50 | 0.51 | 0.51 | 0.50 | 0.51 | 0.51 |
| | BaO | mol % | 0.00 | 0.01 | 0.01 | 0.00 | 0.00 | 0.01 | 0.00 | 0.00 | 0.00 | 0.01 |
| | TiO₂ | mol % | 0.008 | 0.006 | 0.007 | 0.006 | 0.006 | 0.007 | 0.007 | 0.006 | 0.006 | 0.007 |
| | ZrO₂ | mol % | 0.001 | 0.001 | 0.001 | 0.001 | 0.001 | 0.001 | 0.001 | 0.001 | 0.001 | 0.001 |
| | SnO₂ | mol % | 0.077 | 0.085 | 0.081 | 0.085 | 0.084 | 0.085 | 0.085 | 0.080 | 0.081 | 0.080 |
| | Fe₂O₃ | mol % | 0.009 | 0.008 | 0.009 | 0.008 | 0.009 | 0.009 | 0.009 | 0.010 | 0.009 | 0.010 |

| | | | | | | | | | | | |
|---|---|---|---|---|---|---|---|---|---|---|---|
| β-OH | /mm | 0.13 | 0.13 | 0.15 | 0.15 | 0.15 | 0.14 | 0.14 | 0.14 | 0.14 | 0.15 |
| Density | g/cm³ | 2.505 | 2.505 | 2.521 | 2.525 | 2.537 | 2.541 | 2.544 | 2.557 | 2.561 | 2.523 |
| Thermal expansion | ×10⁻⁷/ | 36.2 | 34.4 | 35.6 | 36.8 | 36.8 | 38.0 | 39.2 | 39.2 | 40.4 | 37.6 |
| coefficient | ° C. | | | | | | | | | | |
| Young's modulus | GPa | 86.8 | 88.0 | 89.1 | 88.4 | 90.3 | 89.4 | 88.7 | 90.5 | 90.0 | 88.7 |
| Strain point | ° C. | 743 | 767 | 761 | 762 | 754 | 756 | 757 | 750 | 750 | 753 |
| Temperature at | ° C. | 1258 | 1289 | 1268 | 1268 | 1246 | 1247 | 1249 | 1228 | 1228 | 1261 |
| 10^{4.5} dPa · s | | | | | | | | | | | |
| Liquidus | ° C. | 1241 | 1283 | 1288 | 1270 | 1289 | 1265 | 1293 | 1260 | 1285 | 1262 |
| temperature | | | | | | | | | | | |
| Liquidus viscosity | dPa · s | 4.7 | 4.6 | 4.3 | 4.5 | 4.1 | 4.3 | 4.1 | 4.2 | 4.0 | 4.5 |
| (log η at TL) | | | | | | | | | | | |

TABLE 13

| | | | No. 121 | No. 122 | No. 123 | No. 124 | No. 125 | No. 126 |
|---|---|---|---|---|---|---|---|---|
| Glass | SiO₂ | mol % | 68.81 | 67.29 | 67.30 | 67.25 | 65.83 | 65.86 |
| composition | Al₂O₃ | mol % | 12.50 | 12.50 | 12.50 | 12.55 | 12.48 | 12.48 |
| | B₂O₃ | mol % | 0.00 | 0.00 | 0.00 | 0.00 | 0.00 | 0.00 |
| | Na₂O | mol % | 0.010 | 0.010 | 0.010 | 0.010 | 0.010 | 0.010 |
| | K₂O | mol % | 0.001 | 0.001 | 0.001 | 0.001 | 0.001 | 0.001 |
| | MgO | mol % | 8.03 | 11.03 | 9.55 | 8.00 | 11.00 | 9.52 |
| | CaO | mol % | 10.04 | 8.56 | 10.03 | 11.57 | 10.06 | 11.52 |
| | SrO | mol % | 0.51 | 0.51 | 0.51 | 0.51 | 0.50 | 0.51 |
| | BaO | mol % | 0.00 | 0.01 | 0.00 | 0.00 | 0.01 | 0.00 |
| | TiO₂ | mol % | 0.007 | 0.007 | 0.007 | 0.007 | 0.007 | 0.006 |
| | ZrO₂ | mol % | 0.001 | 0.001 | 0.001 | 0.001 | 0.001 | 0.001 |
| | SnO₂ | mol % | 0.085 | 0.080 | 0.084 | 0.084 | 0.084 | 0.084 |
| | Fe₂O₃ | mol % | 0.010 | 0.011 | 0.009 | 0.010 | 0.010 | 0.010 |

| | | | | | | | |
|---|---|---|---|---|---|---|---|
| β-OH | /mm | 0.15 | 0.13 | 0.13 | 0.15 | 0.13 | 0.13 |
| Density | g/cm³ | 2.527 | 2.540 | 2.544 | 2.548 | 2.561 | 2.565 |
| Thermal expansion | ×10⁻⁷/ | 38.7 | 38.7 | 39.9 | 41.1 | 41.1 | 42.3 |
| coefficient | ° C. | | | | | | |
| Young's modulus | GPa | 88.1 | 89.7 | 89.1 | 88.4 | 90.2 | 89.5 |
| Strain point | ° C. | 754 | 748 | 747 | 746 | 740 | 738 |
| Temperature at | ° C. | 1262 | 1243 | 1242 | 1238 | 1220 | 1222 |
| 10^{4.5} dPa · s | | | | | | | |
| Liquidus | ° C. | 1268 | 1250 | 1251 | 1273 | 1241 | 1260 |
| temperature | | | | | | | |
| Liquidus viscosity | dPa · s | 4.5 | 4.4 | 4.4 | 4.2 | 4.3 | 4.1 |
| (log η at TL) | | | | | | | |

| | | | No. 127 | No. 128 | No. 129 | No. 130 | No. 131 |
|---|---|---|---|---|---|---|---|
| Glass | SiO₂ | mol % | 68.75 | 68.76 | 67.24 | 67.29 | 65.79 |
| composition | Al₂O₃ | mol % | 14.54 | 14.54 | 14.53 | 14.52 | 14.52 |
| | B₂O₃ | mol % | 0.00 | 0.00 | 0.00 | 0.00 | 0.00 |
| | Na₂O | mol % | 0.010 | 0.010 | 0.010 | 0.010 | 0.010 |
| | K₂O | mol % | 0.001 | 0.001 | 0.001 | 0.001 | 0.001 |
| | MgO | mol % | 8.52 | 7.00 | 10.04 | 8.51 | 10.01 |
| | CaO | mol % | 7.56 | 9.05 | 7.56 | 9.05 | 9.05 |
| | SrO | mol % | 0.51 | 0.52 | 0.51 | 0.51 | 0.51 |
| | BaO | mol % | 0.00 | 0.01 | 0.01 | 0.00 | 0.00 |
| | TiO₂ | mol % | 0.007 | 0.007 | 0.007 | 0.007 | 0.007 |
| | ZrO₂ | mol % | 0.001 | 0.001 | 0.001 | 0.001 | 0.001 |
| | SnO₂ | mol % | 0.086 | 0.086 | 0.081 | 0.085 | 0.081 |
| | Fe₂O₃ | mol % | 0.008 | 0.009 | 0.010 | 0.009 | 0.009 |

| | | | | | | |
|---|---|---|---|---|---|---|
| β-OH | /mm | 0.14 | 0.13 | 0.15 | 0.13 | 0.13 |
| Density | g/cm³ | 2.520 | 2.523 | 2.535 | 2.539 | 2.555 |
| Thermal expansion | ×10⁻⁷/ | 34.8 | 36.0 | 36.0 | 37.2 | 38.4 |
| coefficient | ° C. | | | | | |
| Young's modulus | GPa | 89.5 | 88.8 | 90.6 | 90.0 | 91.0 |
| Strain point | ° C. | 767 | 769 | 761 | 761 | 754 |
| Temperature at | ° C. | 1273 | 1278 | 1254 | 1256 | 1236 |
| 10^{4.5} dPa · s | | | | | | |
| Liquidus | ° C. | 1316 | 1280 | 1321 | 1286 | 1289 |
| temperature | | | | | | |
| Liquidus viscosity | dPa · s | 4.1 | 4.5 | 3.9 | 4.2 | 4.0 |
| (log η at TL) | | | | | | |

Each sample was prepared as follows. First, a glass batch obtained by mixing glass raw materials so as to have a glass composition shown in the tables was put into a platinum crucible and melted at 1600° C. for 24 hours. When melting the glass batch, the glass batch was stirred using a platinum stirrer for homogenization. Next, the molten glass was poured onto a carbon sheet, formed into a flat sheet shape, and then cut into a disk shape. For each of the obtained samples, a β-OH value, a density, a thermal expansion coefficient, a Young's modulus, a strain point, a temperature at 10^{4.5} dPa·s, a liquidus temperature, a liquidus viscosity, and a thermal shrinkage were evaluated.

The β-OH value is a value calculated by the above equation.

The density is a value measured by a known Archimedes method.

The thermal expansion coefficient is an average thermal expansion coefficient measured with a dilatometer in a temperature range of 30° C. to 380° C.

The Young's modulus is a value measured by a dynamic elastic modulus measurement method (a resonance method) based on JIS R1602.

The strain point is a value measured based on a method of ASTM C336.

The temperature at a viscosity in high temperature of 10^{4.5} dPa·s is a value measured by a platinum sphere pull up method.

The liquidus temperature is a temperature at which each sample is grinded, a glass powder that passes through a standard sieve of 30 mesh (500 μm) and remains on a sieve of 50 mesh (300 μm) is put into a platinum boat, the platinum boat is held in a temperature gradient furnace set at 1100° C. to 1350° C. for 24 hours, then the platinum boat is taken out, and devitrified crystals (crystal foreign substances) are observed in a glass. The liquidus viscosity is a value obtained by measuring a viscosity of a glass at a liquidus temperature by a platinum sphere pull up method.

As is clear from the tables, Sample Nos. 1 to 131 have a strain point of 715° C. or higher, a temperature at 10^{4.5} dPa·s of 1290° C. or lower, and a Young's modulus of 81.7 GPa or higher, and thus are suitable as a glass disk for a magnetic recording medium.

A glass batch obtained by mixing glass raw materials so as to have a glass composition of each of Sample Nos. 1 to 131 in the tables was put into a melting kiln, melted at 1500° C. to 1700° C. for 24 hours, fined, homogenized, formed into a sheet shape by an overflow down-draw method so as to have a thickness of 0.675 mm, and then processed into a disk shape. A surface roughness Ra of a surface of the obtained glass disk was measured by an atomic force microscope (AFM) and found to be 0.10 nm to 0.20 nm. A total thickness variation (TTV) was 1.0 μm. Further, an average linear transmittance of the obtained glass disk in an optical path length of 1 mm and a wavelength range of 350 nm to 1500 nm was measured with a spectrophotometer UV-3100 manufactured by Shimadzu Corporation, and found to be 85% or more in each case.

1. A glass disk for a magnetic recording medium, wherein
the glass disk has a disk shape, and has a strain point of 695° C. to 780° C., a temperature at 10^{4.5} dPa·s of 1300° C. or lower, and a Young's modulus of 78 GPa or higher.

2. The glass disk for a magnetic recording medium according to claim 1, wherein
a circular opening is formed in a central portion of the glass disk.

3. The glass disk for a magnetic recording medium according to claim 1, wherein
the glass disk contains, as a glass composition, in terms of mol %, 60% to 71% of SiO₂, 10% to 16% of Al₂O₃, 0% to 5% of B₂O₃, 0% to 0.1% of Na₂O, 0% to 1% of K₂O, 0% to 12% of MgO, 0% to 12% of CaO, 0% to 10% of SrO, 0% to 10% of BaO, 0% to 1% of ZrO₂, and 0% to 1% of SnO₂.

4. The glass disk for a magnetic recording medium according to claim 1, wherein
an average surface roughness Ra of a surface of the glass disk is 1.0 nm or less.

5. The glass disk for a magnetic recording medium according to claim 1, wherein
an average linear transmittance in an optical path length of 1 mm and a wavelength range of 350 nm to 1500 nm is 70% or more.

6. A glass disk for a magnetic recording medium, wherein
the glass disk has a disk shape, and contains, as a glass composition, in terms of mol %, 60% to 71% of SiO₂, 10% to 16% of Al₂O₃, 0% to 5% of B₂O₃, 0% to 0.1% of Na₂O, 0% to 1% of K₂O, 0% to 12% of MgO, 0% to 12% of CaO, 0% to 10% of SrO, 0% to 10% of BaO, 0% to 1% of ZrO₂, and 0% to 1% of SnO₂.

7. The glass disk for a magnetic recording medium according to claim 1, wherein
a magnetic layer is provided on a surface of the glass disk.

8. A magnetic recording device, comprising:
the glass disk for a magnetic recording medium according to claim 1.

9. A glass substrate for a magnetic recording medium, wherein
the glass substrate has a strain point of 695° C. to 740° C., a temperature at 10^{4.5} dPa·s of 1300° C. or lower, and a Young's modulus of 78 GPa or higher.

10. The glass substrate for a magnetic recording medium according to claim 9, wherein
the glass substrate contains, as a glass composition, in terms of mol %, 60% to 71% of SiO₂, 10% to 16% of Al₂O₃, 0% to 5% of B₂O₃, 0% to 0.1% of Na₂O, 0% to 1% of K₂O, 0% to 12% of MgO, 0% to 12% of CaO, 0% to 10% of SrO, 0% to 10% of BaO, 0% to 1% of ZrO₂, and 0% to 1% of SnO₂.
